(19) United States
(12) Patent Application Publication
(10) Pub. No.: US 2024/0246016 A1
(43) Pub. Date: Jul. 25, 2024

(54) FILTER HAVING A COIL ARRANGEMENT AND FILTER ASSEMBLY HAVING SUCH A FILTER

(71) Applicant: Carl Freudenberg KG, Weinheim (DE)

(72) Inventor: Ulrich STAHL, Laudenbach (DE)

(21) Appl. No.: 18/414,490

(22) Filed: Jan. 17, 2024

(30) Foreign Application Priority Data
Jan. 25, 2023 (DE) 10 2023 101 829.9

(51) Int. Cl. B01D 46/42; B01D 46/00; B01D 46/52; B60H 3/06

(52) U.S. Cl. CPC B01D 46/4245; B01D 46/0028; B01D 46/0032; B01D 46/0036; B01D 46/521; B60H 3/0608; B01D 2273/22

(57) ABSTRACT

A filter for filtering an air flow, including a filter element with a bellows made of a pleated filter medium, wherein a coil arrangement is integrated into the filter element. A surface of the filter element is provided with the coil arrangement for inducing an electrical voltage. The surface having the coil arrangement is a surface of the bellows on an untreated gas side.

### CROSS REFERENCE TO RELATED APPLICATIONS

This application claims benefit to German Patent Application No. DE 10 2023 101 829.9, filed on Jan. 25, 2023, which is hereby incorporated by reference herein.

### FIELD

The present invention relates to a filter and to a filter assembly having such a filter.

### BACKGROUND

A very wide variety of filters which are used in air filtration are known from the prior art. Filters having pleated filter media are used in the air filtration for vehicle cabins. The filter media can have various layers here, e.g. electrically conductive layers. A layer having an electrostatic layer, which increases the degree of separation of the filter, can also be provided.

WO 2010/049 052 A1 discloses a filter element which is configured as what is referred to as a combination filter. Such a filter element filters particles and adsorbs gases. Filter elements of this type can be used to substantially keep passenger compartments free from harmful substances.

There is the requirement to bring about a particularly high filtration capacity and to admit only very well cleaned air into the passenger compartment. This requirement is met only with difficulty with well-known filter media. Particularly the decrease in the filtration capacity and in particular in the degree of separation causes problems over time.

EP 1 913 990 A1 describes a filter cartridge which has a coil arrangement. By means of the coil arrangement, the filter cartridge can be supplied with electrical energy using electromagnetic induction. For this purpose, a further coil arrangement is provided in a housing of the filter cartridge. The electrical energy can be stored in the filter cartridge and used, for example, for a sensor located there.

### SUMMARY

In an embodiment, the present disclosure provides a filter for filtering an air flow, comprising a filter element with a bellows made of a pleated filter medium, wherein a coil arrangement is integrated into the filter element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a perspective view of a filter;

FIG. 2a illustrates a top view of a filter element;

FIG. 2b illustrates a view of an edge strip;

FIGS. 2c-d illustrate alternative coil forms;

FIG. 3 illustrates a schematic view of a filter assembly; and

FIGS. 4a-c illustrate cross sections through filter media having a plurality of layers.

### DETAILED DESCRIPTION

In an embodiment, the present invention provides a filter and a filter assembly having a good degree of particle separation over a relatively long period of use.

According to an embodiment of the invention, it has been recognized as being advantageous to provide the filter element with a coil arrangement such that a voltage can be induced in the filter element.

The filter according to an embodiment of the invention serves for filtering a fluid flow, in particular an air flow, wherein the filter has a filter element with a bellows made of a pleated filter medium. The filter element can furthermore also have edge strips—alternatively referred to as edge tapes—which delimit the bellows.

According to an embodiment of the invention, a coil arrangement is integrated into the filter element, for inducing an electrical voltage. This permits what is referred to as inductive energy transfer or inductive coupling. The coil arrangement may also be referred to as a secondary coil or receiver coil. The voltage induced in the coil arrangement can be used to increase the electrostatic charging of the filter element and thus to increase the degree of particle separation.

Since the coil arrangement is located integrated directly in or on the filter element, particularly simple manufacturing of the filter is possible. A complicated attachment of a coil arrangement is avoided.

The coil arrangement having its conductive elements can have a very wide variety of geometrical configurations as long as it can carry out the function of an electric coil. Lattice-like or serpentine-shaped or meandering coil geometries are thus conceivable.

In an advantageous embodiment, the surface of the filter element is provided with the coil arrangement.

According to a first embodiment variant of the filter, the surface having the coil arrangement is the surface on the untreated gas side, i.e. that surface of the bellows which is placed upstream in the direction of flow of the fluid flow.

The coil arrangement can extend here over part of the surface of the bellows and can be attached to the surface.

According to a second embodiment variant of the filter, the filter element has at least one edge strip and the at least one edge strip is fastened to the bellows. In an advantageous manner, the surface having the coil arrangement is a surface of the edge strip, in particular an outer surface.

In an advantageous embodiment of the filter, the coil arrangement is formed by a print on the filter element. The print can be made with an electrically conductive dye or paste, either on the filter medium before the latter is pleated, or on the edge strip.

In a refinement of the filter, the coil arrangement is formed by a nonwoven layer of the filter medium or of the edge strip, which is provided with metallic fibers or with metallic particles.

In a development of the filter, the coil arrangement is formed by concentric lines on the filter element, i.e. the bellows or edge tape.

In an advantageous embodiment of the filter, the surface of the filter element is provided with conducting elements, which are electrically conductively connected to the coil arrangement or are part of the coil arrangement. The purpose of this is that the coil arrangement is able to receive voltage induced from a mating coil, and then distributes charge across the conducting elements on the surface of the bellows. The conducting elements form a conductive layer of the filter medium, said layer ideally lying on the incident flow side of the filter. The induction of additional charge thus enables the degree of particle separation to be particularly readily increased. Alternatively, an arrangement on the discharge flow side is also provided. This is advantageous in particular in the case of a progressive building up of the filter medium.

The filter medium can be formed from nonwoven material, multilayer nonwoven material, multilayer nonwoven material with microfiber, multilayer nonwoven material with an active carbon layer, multilayer nonwoven material with a functional finish against allergens and microbiological substances, or from multilayer nonwoven material with an active carbon layer and with a functional finish against allergens and microbiological substances.

The coil arrangement can be formed from metallic fibers or from fibers with metallic particles or from a paste with electrically conductive particles, e.g. graphenes or graphene oxides, or metal particles or other electrically conductive particles.

An embodiment of the invention also relates to a filter assembly comprising a filter as described above and a housing in which the filter is accommodated. The housing can also be configured as a frame, shaft or the like.

According to an embodiment of the invention, the housing is equipped with a coil arrangement for generating an electromagnetic field, wherein the coil arrangement may be referred to as a primary coil or transmission coil. The coil arrangement of the housing and the coil arrangement of the filter element are positioned relative to each other in such a way that generation of an induced voltage in the coil arrangement of the filter element is made possible. That is to say, there is no direct power-conducting contact between the coil arrangements, and the latter are spaced apart from one another, preferably by less than 2 cm. A particularly good inductive energy transmission is then made possible.

In a development of the filter arrangement, the induced voltage generated in the coil arrangement of the filter element is distributed by a line system having conducting elements on the surface of the bellows, so that an increased electrical charge is generated on the surface of the bellows, which increases the degree of particle separation. In particular, the particle separation rate according to DIN 71460-1 for NaCl particles is thus increased by at least 20% compared to the state without a coil arrangement. In a development, the degree of particle separation is increased by at least 30% by high voltage being produced.

An embodiment of the invention also relates to the use of a filter assembly as previously described as an interior air filter for the cabin of a motor vehicle.

The described embodiments of the invention and the described advantageous developments of the invention are also advantageous developments of the invention in combination with one another, if this is technically feasible.

With regard to further advantages and in a structural and functional respect of advantageous refinements of the invention, reference is made to the description of exemplary embodiments with reference to the attached figures.

Embodiments of the invention will be explained in more detail below with reference to attached figures. Mutually corresponding elements and components are provided with the same reference signs in the figures. For better clarity of the figures, an illustration true to scale has been omitted.

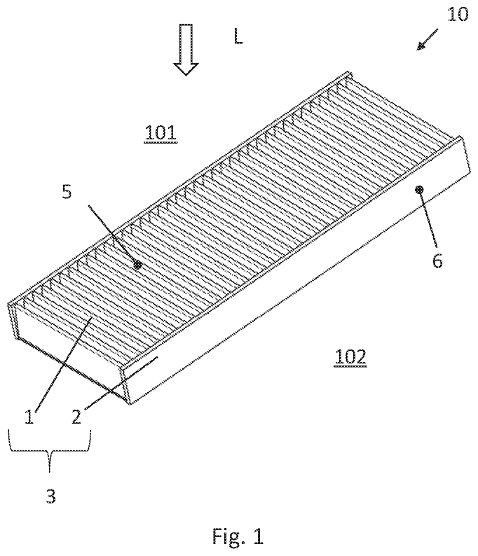

FIG. 1 illustrates a perspective view of a filter. The filter 10 serves for filtering an air flow L, wherein the filter 10 has a filter element 3 with a bellows 1 made of a pleated filter medium 7, and the filter element 3 has two edge strips 2, and the edge strips 2 are fastened to the bellows 1.

The surface of the filter element 3 is provided with a coil arrangement 4 for inducing an electrical voltage. The coil arrangement 4 can be attached to the surface of the bellows 1 on the untreated gas side 101 (position 5) or to a surface of the edge strip 2 (position 6).

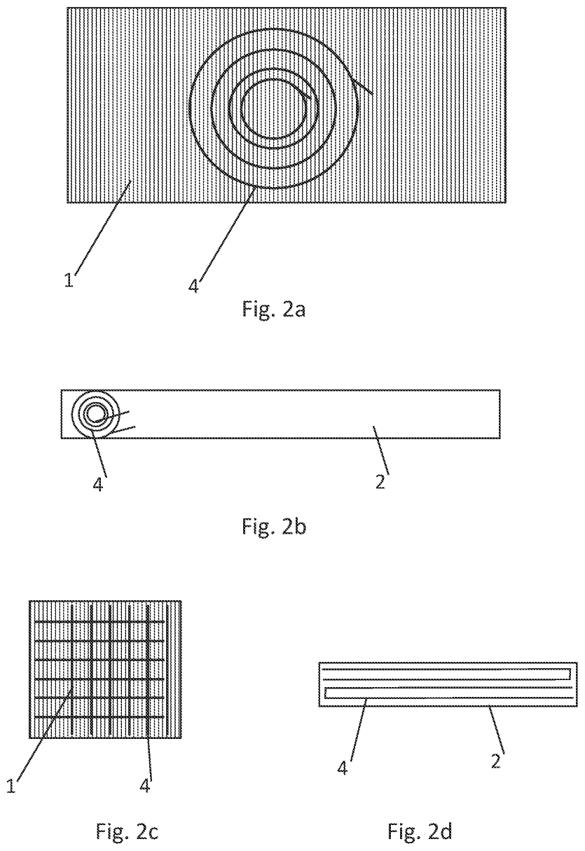

FIG. 2a illustrates a top view of a filter element. In this exemplary embodiment, the coil arrangement 4 is formed by concentric lines on the bellows 1 of the filter element 3. In the variant of FIG. 2c, it is formed by a lattice-like geometry.

FIG. 2b illustrates a view of an edge strip. In this exemplary embodiment, the coil arrangement 4 is formed by concentric lines on an edge tape 2 of the filter element 3. In the variant of FIG. 2d, it is formed by a reduced meandering shape.

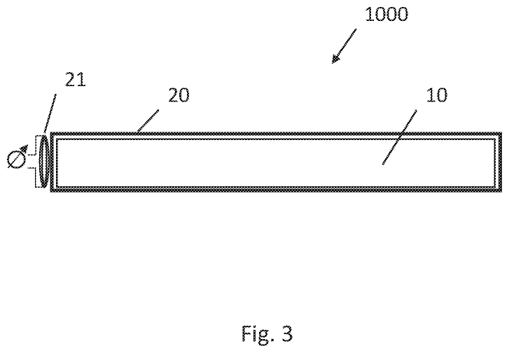

FIG. 3 illustrates a schematic view of a filter assembly. The filter assembly 1000 comprises a filter 10 and a housing 20 in which the filter 100 is accommodated. The housing 20 is equipped with a coil arrangement 21 for generating an electromagnetic field, and the coil arrangement 21 of the housing 20 and the coil arrangement 4 of the filter element 3 are positioned relative to each other in such a way that generation of an induced voltage in the coil arrangement 4 of the filter element is made possible.

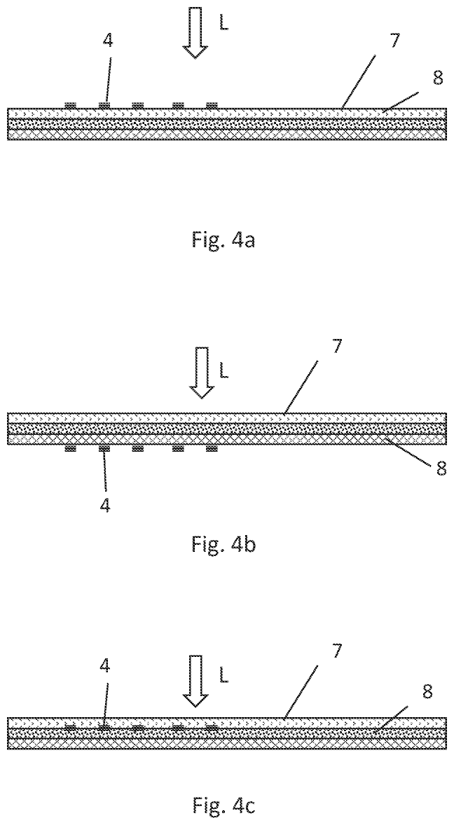

FIG. 4a illustrates a cross section through a filter medium having a plurality of layers. The coil arrangement 4 is formed by a print on the filter medium 7.

The uppermost layer of the filter medium 7 and therefore the surface of the filter medium 7 is provided with conducting elements which are electrically conductively connected to the coil arrangement 4.

As a result, the induction voltage produced in the coil arrangement 4 of the filter element can be distributed by a line system having conducting elements on the surface of the bellows 1, so that an increased electrical charge is generated on the surface of the bellows 1, which increases the degree of particle separation.

The filter medium 7 illustrated is formed from a multilayer nonwoven material with a central active carbon layer.

In the variant of FIG. 4b, the coil arrangement 4 is attached to the surface of the filter medium 7 on the pure gas side. The filter medium 7 can have a progressive buildup here. This means that the layers of the filter medium become ever finer—in the throughflow direction of the air flow L.

In the variant of FIG. 4c, the coil arrangement 4 is attached to the surface of a layer 8 of the filter medium 7, the layer 8 being an interior layer of the filter medium 7.

In an alternative refinement of a filter assembly, the charging of the surface of the filter element could also be generated by a high voltage being applied to conducting elements of the filter element. The transmission can be undertaken by wired connection, e.g. copper cables. A high voltage is understood here as meaning an electrical voltage of greater than 5 kV, in particular of 10 kV with a low current strength of below 10 mA.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A filter for filtering an air flow, comprising:
a filter element with a bellows made of a pleated filter medium,
wherein a coil arrangement is integrated into the filter element.

2. The filter according to claim 1, wherein a surface of the filter element is provided with the coil arrangement for inducing an electrical voltage.

3. The filter according to claim 2, wherein the surface having the coil arrangement is a surface of the bellows on an untreated gas side.

4. The filter according to claim 3, wherein the coil arrangement is attached to the surface of the bellows.

5. The filter according to claim 2, wherein the filter element has at least one edge strip and the at least one edge strip is fastened to the bellows, and
wherein the surface having the coil arrangement is a surface of the edge strip.

6. The filter according to claim 1, wherein the filter medium has at least one layer and the coil arrangement is arranged on a surface of the at least one layer.

7. The filter according to claim 1, wherein the coil arrangement is formed by a print on the filter element.

8. The filter according to claim 1, wherein the coil arrangement is formed by a nonwoven layer, which is provided with one of metallic fibres, conductive metallic particles, a conductive paste, graphenes, or graphene oxides.

9. The filter according to claim 1, wherein the coil arrangement is formed by concentric lines on the filter element.

10. The filter according to claim 1, wherein the surface of the filter element is provided with conducting elements, which are electrically conductively connected to the coil arrangement.

11. The filter according to claim 1, wherein the filter medium is formed from nonwoven material, multilayer nonwoven material, multilayer nonwoven material with microfibres, multilayer nonwoven material with an active carbon layer, multilayer nonwoven material with a functional finish against allergens and/or microbiological substances, or from multilayer nonwoven material with an active carbon layer and with a functional finish against allergens and/or microbiological substances, and/or
wherein the coil arrangement is formed from one of metallic fibres, fibres with conductive metallic particles, a paste with electrically conductive particles, graphenes, or graphene oxides.

12. A filter assembly comprising the filter according to claim 1 and a housing in which the filter is accommodated,
wherein the housing is equipped with a coil arrangement for generating an electromagnetic field, and the coil arrangement of the housing and the coil arrangement of the filter element are positioned relative to each other in such a way as to provide for generation of an induced voltage in the coil arrangement of the filter element.

13. The filter assembly according to claim 12, wherein the induced voltage generated in the coil arrangement of the filter element is distributed by a line system having conducting elements on a surface of the bellows, so that an increased electrical charge is generated on the surface of the bellows, which increases a particle separation rate.

14. The filter assembly according to claim 12, wherein the filter assembly is arranged in an interior cabin of a motor vehicle.

15. A method for increasing an electrostatic charge of the filter according to claim 1, comprising:
providing the filter in a filter assembly.
